(19) United States
(12) Patent Application Publication
(10) Pub. No.: US 2013/0080976 A1
(43) Pub. Date: Mar. 28, 2013

(54) MOTION CONTROLLED LIST SCROLLING

(71) Applicants: Joel Zambrano, Bothell, WA (US); Shawn Lucas, Redmond, WA (US); Jeffery W. Hartin, Carnation, WA (US); Michael Steinore, Snohomish, WA (US)

(72) Inventors: Joel Zambrano, Bothell, WA (US); Shawn Lucas, Redmond, WA (US); Jeffery W. Hartin, Carnation, WA (US); Michael Steinore, Snohomish, WA (US)

(73) Assignee: MICROSOFT CORPORATION, Redmond, WA (US)

(21) Appl. No.: 13/247,828

(22) Filed: Sep. 28, 2011

(51) Int. Cl. G06F 3/048

(52) U.S. Cl. 715/830

(57) ABSTRACT

Motion controlled list scrolling includes outputting to a display device a user interface including a plurality of selectable items and receiving a world space position of a hand of a human subject. Responsive to the position of the hand of the human subject being within a first region, the plurality of selectable items are scrolled a first direction. Responsive to the position of the hand being within a second region, the plurality of selectable items are scrolled a second direction. Responsive to the world space position of the hand of the human subject being within a third region, the plurality of selectable items are held with one of the plurality of selectable items identified for selection.

### BACKGROUND

It is common for a user interface to include many selectable items. Often the number of selectable items is large enough that they are not all displayed in the same view, and a user must scroll to view items of interest. Many mobile devices, computers, gaming consoles and the like are configured to output such an interface.

A user may scroll by providing input via a variety of input devices. Some input devices may be cumbersome to use, and may require a large amount of repeated user actions to scroll a list.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

According to one aspect of this disclosure, scrolling includes outputting to a display device a user interface including a plurality of selectable items. One or more depth images of a world space scene including a human subject may be received from a depth camera. In addition, a world space position of a hand of the human subject may be received. Responsive to the world space position of the hand of the human subject being within a first region, the plurality of selectable items are scrolled a first direction within the user interface. Similarly, responsive to the world space position of the hand of the human subject being within a second region, the plurality of selectable items are scrolled a second direction, opposite the first direction, within the user interface. Also, responsive to the world space position of the hand of the human subject being within a third region, between the first region and the second region, the plurality of selectable items are held with one of the plurality of selectable items identified for selection.

### BRIEF DESCRIPTION OF THE DRAWINGS

FIG. 1 schematically shows an example scrolling environment in accordance with an embodiment of the present disclosure.

FIG. 2 shows a depth image processing pipeline in accordance with an embodiment of the present disclosure.

FIGS. 3A, 3B, and 3C show an example user interface scrolling responsive to an example virtual skeleton.

FIG. 4 shows an example method of scrolling in a user interface in accordance with an embodiment of the present disclosure

FIGS. 5A, 5B, and 5C schematically show example user interfaces in accordance with embodiments of the present disclosure.

FIG. 6 schematically shows a computing system for performing the method of FIG. 4.

### DETAILED DESCRIPTION

The present description is related to scrolling a plurality of selectable items in a user interface. The present description is further related to scrolling via input devices which allow natural user motions and gestures to serve as impetus for the scrolling.

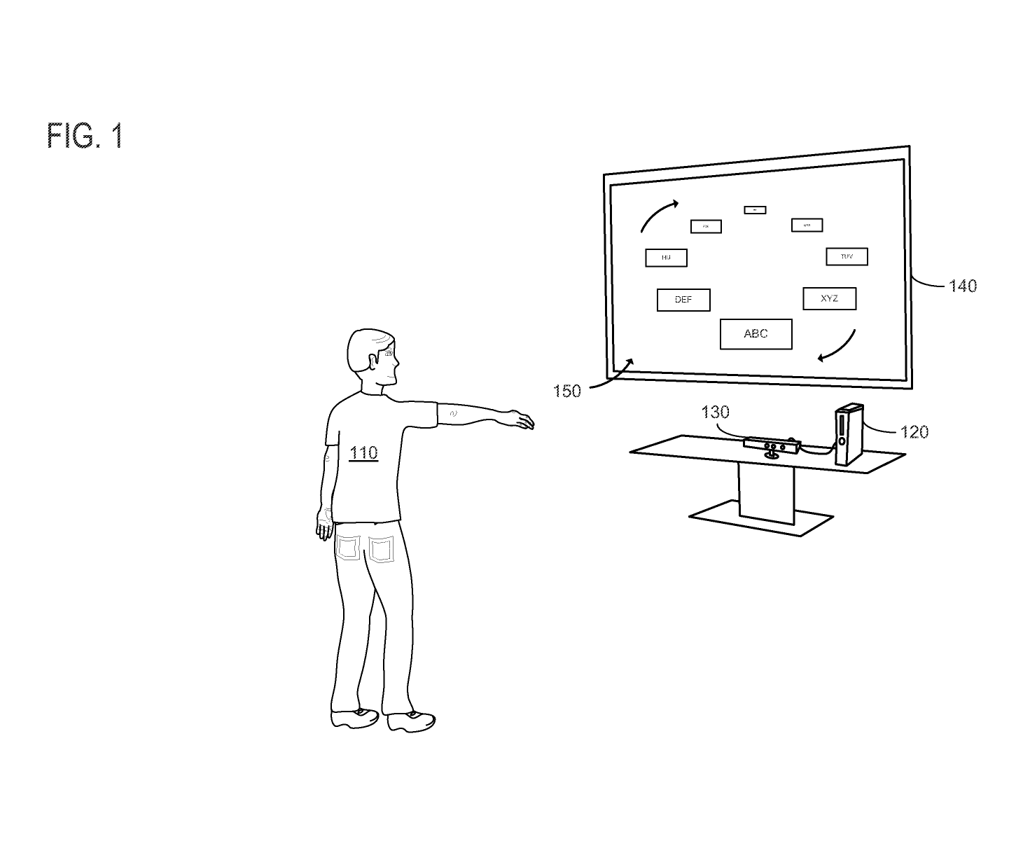

FIG. 1 shows an example scrolling environment including a human subject 110, a computing system 120, a depth camera 130, a display device 140 and a user interface 150. The display device 140 may be operatively connected to the computing system 120 via a display output of the computing system. For example, the computing system 120 may include an HDMI or other suitable display output. The computing system 120 may be configured to output to the display device 140 a carousel user interface 150 including a plurality of selectable items.

Computing system 120 may be used to play a variety of different games, play one or more different media types, and/or control or manipulate non-game applications and/or operating systems. In the illustrated embodiment, display device 140 is a television, which may be used to present visuals to users and observers.

The depth camera 130 may be operatively connected to the computing system 120 via one or more inputs. As a nonlimiting example, the computing system 120 may include a universal serial bus to which the depth camera 130 may be connected. The computing system 120 may receive from the depth camera 130 one or more depth images of a world space scene including the human subject 110. Depth images may take the form of virtually any suitable data structure, including but not limited to, a matrix of pixels, where each pixel includes depth information that indicates a depth of an object observed at that pixel. Virtually any depth finding technology may be used without departing from the scope of this disclosure.

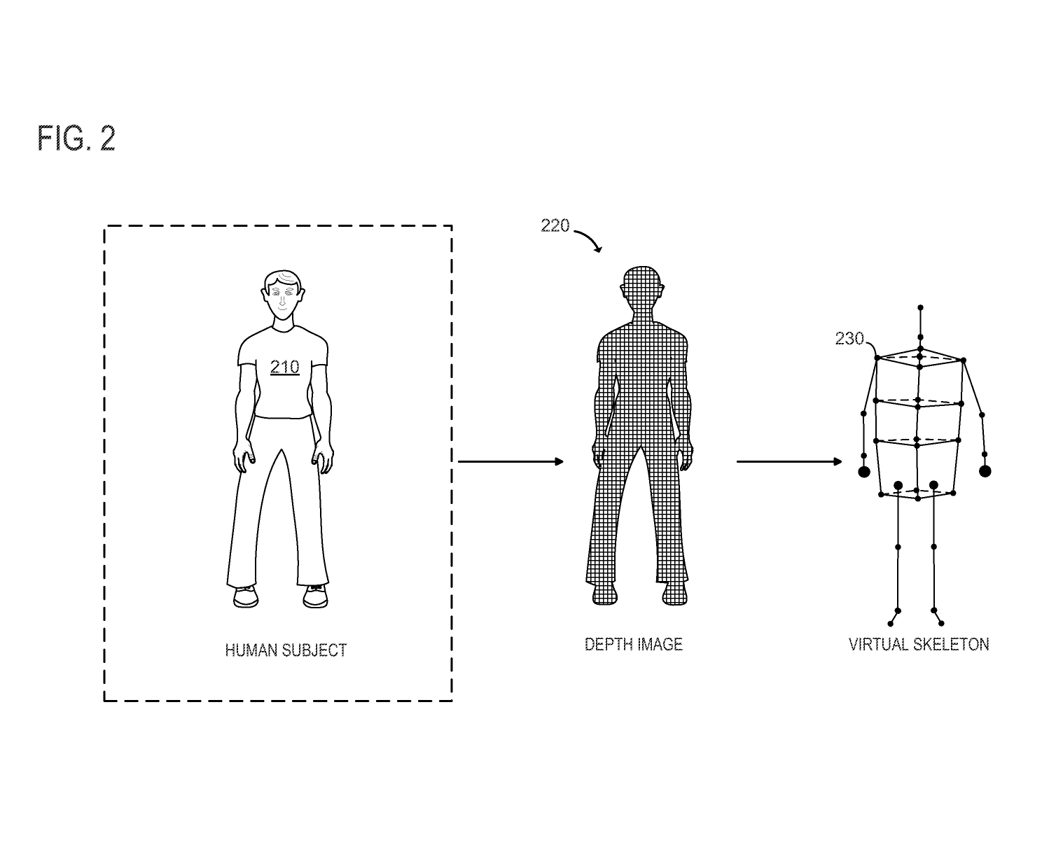

Depth images may be used to model human subject 110 as a virtual skeleton. FIG. 2 shows a simplified processing pipeline where a depth camera is used to provide a depth image 220 that is used to model a human subject 210 as a virtual skeleton 230. It will be appreciated that a processing pipeline may include additional steps and/or alternative steps than those depicted in FIG. 2 without departing from the scope of this disclosure.

As shown in FIG. 2, the three-dimensional appearance of the human subject 210 and the rest of an observed scene may be imaged by a depth camera. In FIG. 2, a depth image 220 is schematically illustrated as a pixilated grid of the silhouette of the human subject 210. This illustration is for simplicity of understanding, not technical accuracy. It is to be understood that a depth image generally includes depth information for all pixels, not just pixels that image the human subject 210.

A virtual skeleton 230 may be derived from the depth image 220 to provide a machine-readable representation of the human subject 210. In other words, the virtual skeleton 230 is derived from depth image 220 to model the human subject 210. The virtual skeleton 230 may be derived from the depth image 220 in any suitable manner. In some embodiments, one or more skeletal fitting algorithms may be applied to the depth image. The present disclosure is compatible with virtually any skeletal modeling techniques.

The virtual skeleton 230 may include a plurality of joints, and each joint may correspond to a portion of the human subject 210. Virtual skeletons in accordance with the present disclosure may include virtually any number of joints, each of which can be associated with virtually any number of parameters (e.g., three dimensional joint position, joint rotation, body posture of corresponding body part (e.g., hand open, hand closed, etc.) etc.). It is to be understood that a virtual skeleton may take the form of a data structure including one or more parameters for each of a plurality of skeletal joints (e.g., a joint matrix including an x position, a y position, a z position, and a rotation for each joint). In some embodiments, other types of virtual skeletons may be used (e.g., a wireframe, a set of shape primitives, etc.).

Instead of or in addition to modeling a human subject with a virtual skeleton, the position of the body part of a human subject may be determined using other mechanisms. As a nonlimiting example, a user may hold a motion control device (e.g., a gaming wand), and the position of a human subject's hand may be inferred by the observed position of the motion control device.

Turning back to FIG. 1, the computing system 120 may be configured to identify a world space position of a hand of human subject 110. The world space position of the hand may be identified using any number of techniques, such as via a virtual skeleton, as described above. The computing system 120 may be configured to scroll or hold scrollable items presented by the user interface 150 depending on the position of the hand.

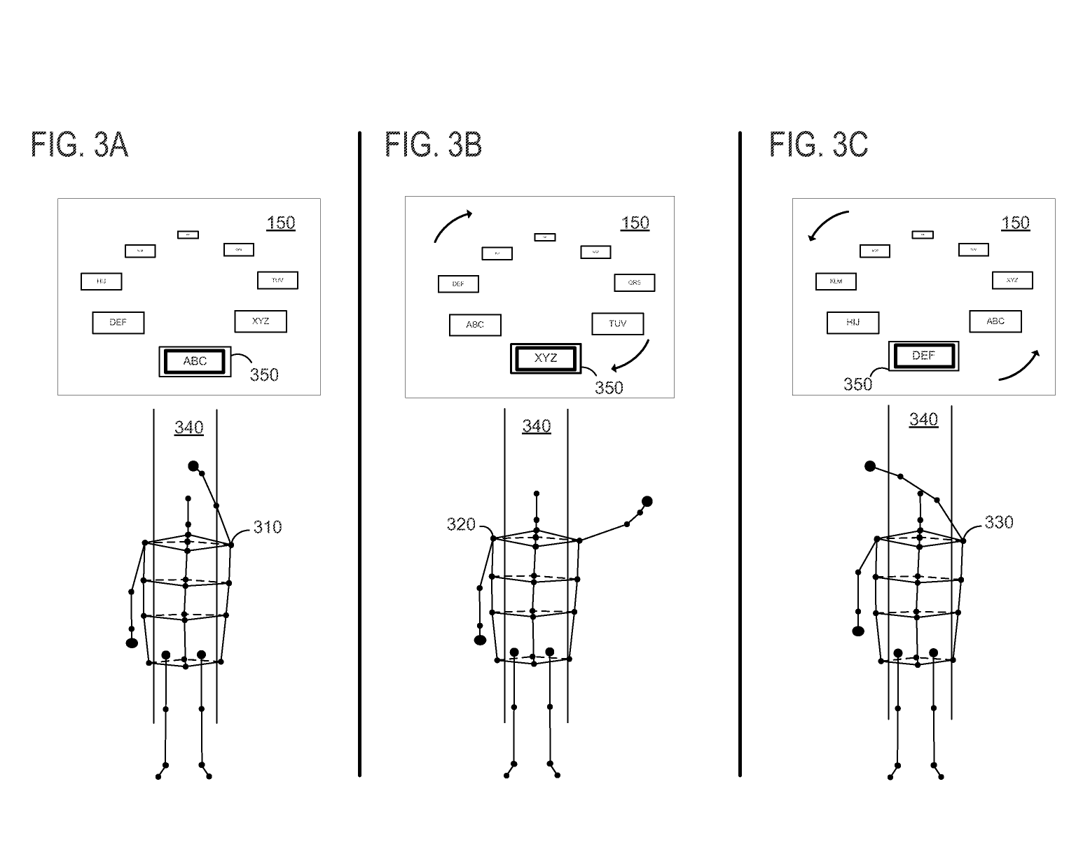

For example, FIGS. 3A, 3B, and 3C show virtual skeletons 310, 320, and 330, respectively, of the human subject 110, as well as corresponding carousel user interfaces 150, each at different moments in time. Each of the virtual skeletons correspond to a gesture that human subject 110 may make to scroll or hold the selectable items.

The shown gestures may be used to scroll or hold the scrollable items of user interface 150. For example, responsive to the world space position of the hand of the human subject being within a neutral region 340, as shown by virtual skeleton 310 in FIG. 3A, the plurality of selectable items may be held in a fixed or slowly moving position with one of the plurality of selectable items identified for selection.

In the illustrated embodiment, item 350 is identified for selection by nature of its position in the front center of the user interface, large size relative to other items, and visually emphasized presentation. It is to be understood that an item may be identified for selection in virtually any manner without departing from the scope of this disclosure. Furthermore, one item will typically always be identified for selection, even when the plurality of selectable items are scrolling.

Responsive to the world space position of the hand of the human subject being outside (from the perspective of the user) of the neutral region 340 to a first side, as shown by virtual skeleton 320 in FIG. 3B, the plurality of selectable items may be scrolled clockwise, and responsive to the world space position of the hand of the human subject being outside of the neutral region 340 to a second side, as shown by virtual skeleton 330 in FIG. 3C, the plurality of selectable items may be scrolled counter-clockwise.

The scroll speed in both the clockwise and counter-clockwise direction may be any suitable speed, such as a constant speed or a speed proportional to a distance of the hand from the neutral region 340. An item identified for selection may be selected by the human subject 110 in virtually any suitable manner, such as by performing a push gesture.

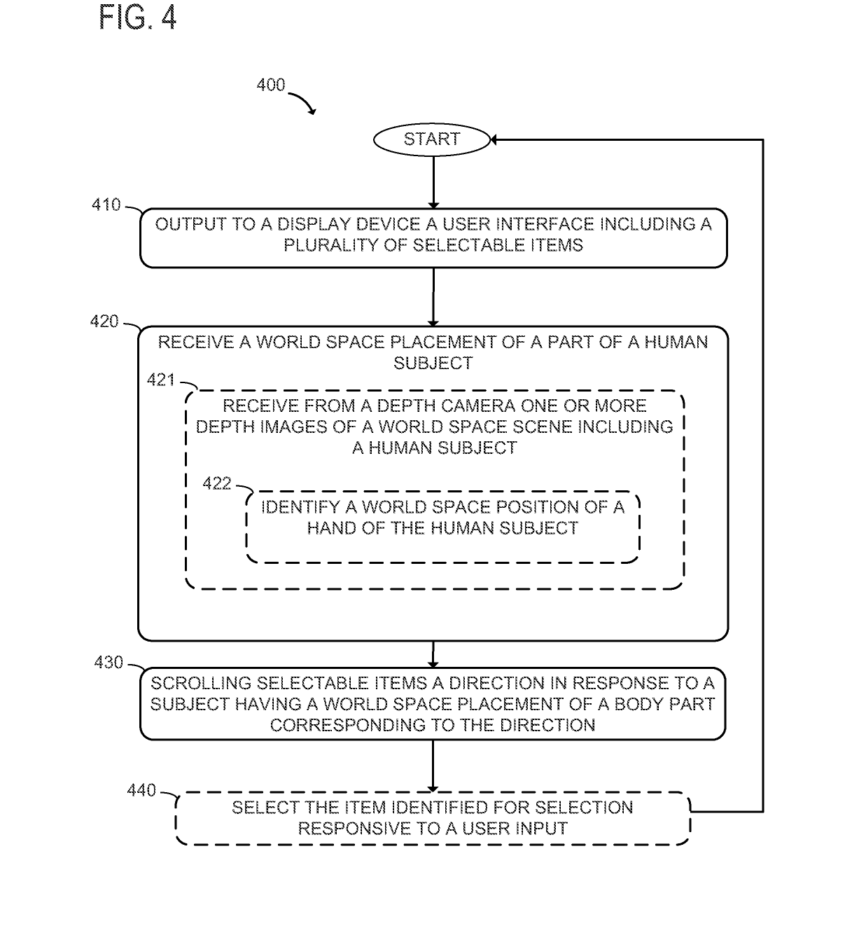

FIG. 4 shows an embodiment of a method 400 for controlling a user interface including a plurality of selectable items, including but not limited to user interface 150 of FIG. 1. At 410, the method 400 may include outputting to a display device a user interface including a plurality of selectable items. The display device may be any device suitable for visually displaying data, such as a mobile device, a computer screen, or a television. The selectable items may be associated with any suitable data object, such as a song, a picture, an application, or a video, for example. As nonlimiting examples, selecting an item may trigger a song to be played or a picture to be displayed.

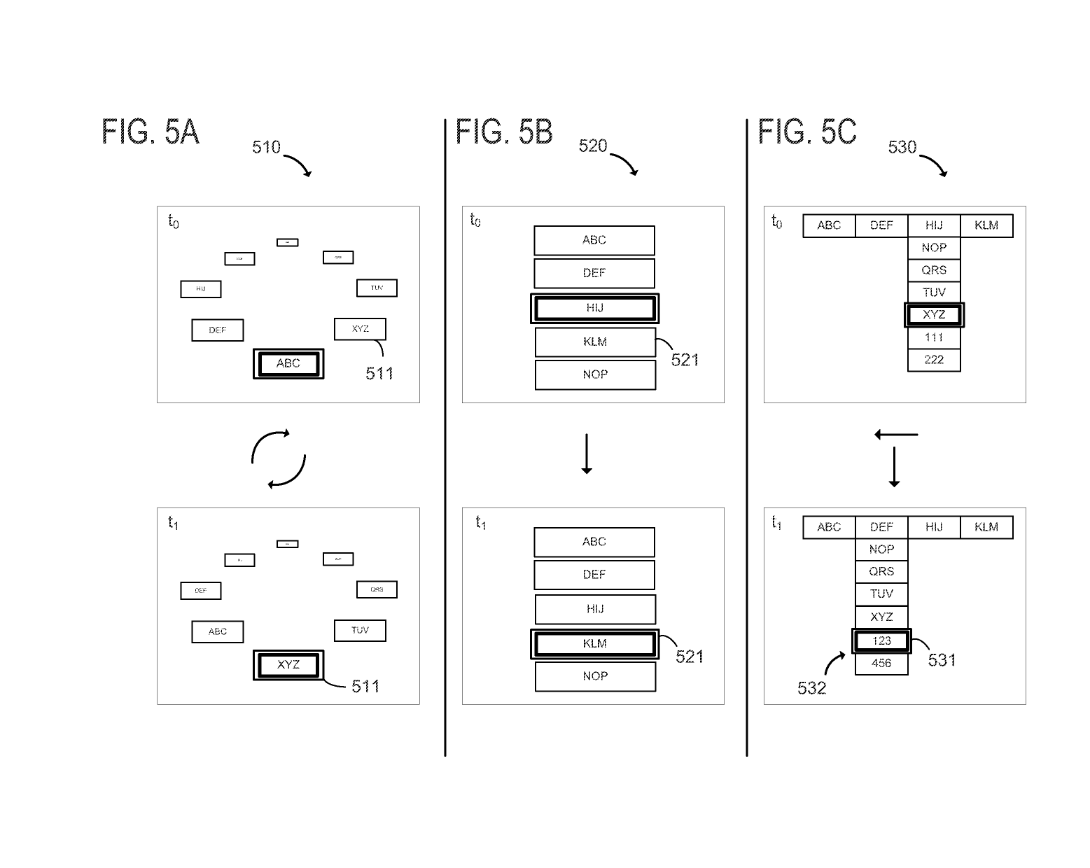

The user interface may show the plurality of selectable items organized in a variety of different ways. Some example user interfaces are shown in FIGS. 5A, 5B, and 5C. In particular, FIG. 5A shows exemplary carousels 510, FIG. 5B shows exemplary 1-D list 520, FIG. 5C shows exemplary 2-D list 530. Each of the user interfaces are shown at a time to before scrolling, and a time t₁ after scrolling. The user interfaces may change appearance from time t₀ to t₁. For example, carousel 510 may appear to have visually rotated to identify item 511 for selection, the 1-D list 520 may have a different item 521 identified for selection, and 2-D list 530 may present another column 532 of items with another item 531 identified for selection.

Identifying an item for selection may include providing a clue that a subsequent user input will initiate an action associated with selecting the item. Such clues may be visual, such as highlighting or otherwise marking the item, or by displaying the item more prominently than the other items. In some embodiments a clue may be audible. It should be appreciated that virtually any method of identifying an item for selection may be utilized without departing from the scope of this disclosure.

In some embodiments, scrolling causes a display to show new items not previously shown on the display. For example, a 1-D list may always have the center item identified for selection, and scrolling may cause a new set of items to populate the list, thereby identifying another item for selection.

The shown user interfaces are exemplary in nature and meant for ease of understanding. It should be appreciated that a user interface compatible with the present disclosure may contain more or less graphics, icons, or other items not shown in FIGS. 5A, 5B, and 5C, and that virtually any user interface can be utilized without departing from the scope of this disclosure.

Turning back to FIG. 4, the method 400 may include, at 420, receiving a world space placement of a body part of a human subject. As used herein, world space refers to the physical space in which the human subject exists (e.g., a living room). A placement may include a 3-D position and/or orientation of a body part of that user. For example, placement may include an orientation of a head, a 3-D position and/or orientation of a hand, and/or a direction a human is facing. In some embodiments, a placement may involve more than one body part, such as the distance from one hand to another or a position/orientation of one person's body part relative to another body part or person.

In some embodiments, a placement may include a 1-D position. For example, the world space placement of the body part may refer to a placement of the body part with reference to a first axis in world space, independent of the placement of the body part with reference to other axes that are not parallel to the first axis. In other words, off-axis movement of a body part may be ignored for the purposes of scrolling. For example, the position of a hand to the left and right may be considered without regard to the position of the hand up and down or front and back. In this way, a person may move their hand (or any body part) in a direction without having to unnecessarily restrict the motion of that body part in another direction.

As indicated at 421, one or more depth images of a world space scene including a human subject may be received from a depth camera. The depth images may be processed to determine a world space placement of a body part. For example, as described with reference to FIG. 3, a virtual skeleton can be used to model a human subject, and the joints and/or other aspects of the virtual skeleton can be used to determine the world space placement of corresponding body parts of the human subject. Other methods and devices may be used to determine a world space placement of a body part without departing from the scope of this disclosure. For example, a conventional camera capable of observing and outputting visible light data may be utilized. The visible light data may be processed to determine a world space placement of a body part. Facial recognition, object recognition, and object tracking can be employed to process the visible light data, for example.

As indicated at 422, a world space position of a hand of a human subject may be identified. The position of the hand may be identified using a virtual skeleton, for example. In such cases, the position of a hand joint of the virtual skeleton can be used to determine the world space position of the actual hand of the human subject. Although the position of a hand of a human subject may be identified, the position of the hand need not be visually presented to the human subject. For example, a user interface may be a cursorless user interface without a visual element indicating a position of the hand. It is believed that in some instances, a cursorless user interface may provide a more intuitive experience to users of the interface.

The method 400 may include, at 430, scrolling selectable items a direction in response to a subject having a world space placement of a body part corresponding to the direction. Scrolling selectable items a direction may include essentially any suitable method of re-organizing a display of selectable items, such as those described with reference to FIGS. 5A, 5B, and 5C. However, other scrolling techniques may be utilized as well. For example, three dimensional scrolling may be by initiated by a user to switch to viewing another set of selectable items, or to change from a list display to a carousel display. Higher dimensional scrolling may be implemented, such as by scrolling in two diagonal directions, a horizontal direction, and a vertical direction. It is to be appreciated that virtually any number of scrolling techniques may be utilized without departing from the scope of this disclosure.

In some embodiments, the plurality of selectable items are scrolled with a scroll speed according to a function of the placement of the body part of the human subject. For example, the function may be a step function of the world space placement of the body part (e.g. distance of a hand from a neutral region) of the human subject, or another function that increases with a distance from a region, such as a neutral region. A neutral region may be a region in which the scroll speed is zero. In other words, if a body part of a human subject is placed in a neutral region, scrolling may be stopped or slowed while the plurality of items are held with one identified for selection. For example, FIGS. 3A, 3B, and 3C show a neutral region 340 in a virtual position corresponding to a world space position directly in front of a human subject. In such an example, the farther the hand of the virtual skeleton moves to the left or right away from the neutral region 340, the faster the selectable items may scroll. It should be appreciated that any suitable function which maps a world space placement of a body part to a scroll speed in a predictable way may be utilized without departing from the scope of this disclosure.

A placement of a body part may be mapped to a scroll direction and speed via any suitable method, for any suitable user interface. For example, responsive to the world space placement of the body part of the human subject having a first placement (e.g., left of a neutral region), the plurality of selectable items may be scrolled a first direction within the user interface (e.g., counter-clockwise), and responsive to the world space placement of the body part of the human subject having a second placement (e.g., right of the neutral region), the plurality of selectable items may be scrolled a second direction, opposite the first direction, within the user interface (e.g., clockwise).

The scroll direction may be determined via any suitable method. In general, a scroll direction may be selected to correspond to a world space direction that matches a human subject's intuition. For example, a left scroll can be achieved by moving a hand to the left, while a down scroll can be achieved by moving a hand down. Virtually any correlation between world space body part placement and scroll direction may be established.

Furthermore, a placement of a body part is not necessarily restricted to being characterized by the world space position of that body part. A placement may be characterized by an attribute of a body part. Such attributes may include a wink of an eye, an orientation of a head, or a facial expression, for example. The plurality of selectable items may be scrolled responsive to a state of the attribute of the body part. One state may cause the items to be scrolled a first direction, and another state may cause the items to be scrolled another direction. For example, closing a left eye may cause a list to scroll left, and closing a right eye may cause the list to be scrolled right. It should be appreciated that an attribute may be a world space placement of a hand, as described above. Additionally, an attribute of a body part may include a position of a first portion of the body part relative to a position of a second portion of the body part. For example, a human subject could move one finger away from another finger to achieve a desired scrolling effect.

In some embodiments, responsive to the world space placement of the body part of the human subject having a third placement, intermediate the first placement and the second placement, the plurality of selectable items may be held with one of the plurality of selectable items identified for selection. As an example, FIG. 3A shows a virtual skeleton 310 with a left hand held directly forward in a neutral region 340. In this example, the neutral hand placement causes user interface 150 to hold the plurality of selectable items with selectable item 350 identified for selection.

At 440, the method 400 may include selecting the item identified for selection responsive to a user input. User inputs may include virtually any input, such as a gesture or a sound. For example, a user may make a push gesture to select an item that is identified for selection. Other gestures could be used, such as a step, or a head nod for example. Alternatively, the user could speak, such as by saying select, or go. Combinations of gestures and sounds may be utilized, such as by clapping. Upon selecting an item, any number of actions could be taken, such as playing a song, presenting new data, showing a new list, playing a video, calling a friend, etc.

In some embodiments, the above described methods and processes may be tied to a computing system including one or more computers. In particular, the methods and processes described herein may be implemented as a computer application, computer service, computer API, computer library, and/or other computer program product.

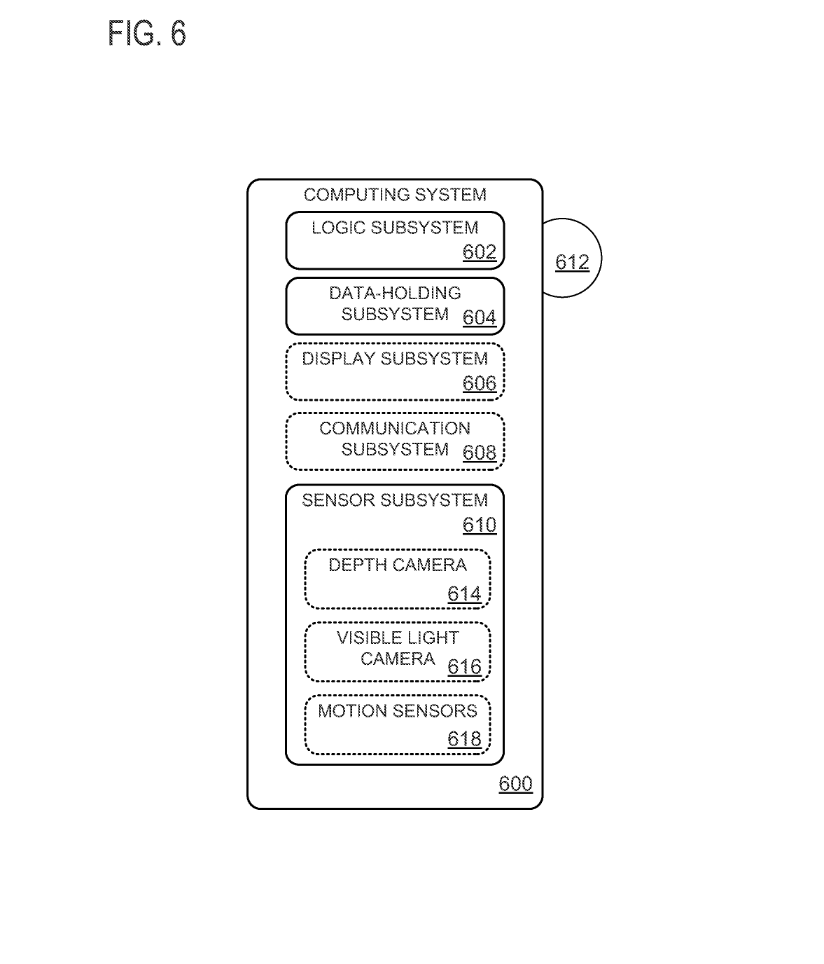

FIG. 6 schematically shows a nonlimiting computing system 600 that may perform one or more of the above described methods and processes. Computing system 600 is shown in simplified form. It is to be understood that virtually any computer architecture may be used without departing from the scope of this disclosure. In different embodiments, computing system 600 may take the form of a mainframe computer, server computer, desktop computer, laptop computer, tablet computer, home entertainment computer, network computing device, mobile computing device, mobile communication device, gaming device, etc. Computing system 120 of FIG. 1 is a nonlimiting example of computing system 600.

Computing system 600 includes a logic subsystem 602 and a data-holding subsystem 604. Computing system 600 may optionally include a display subsystem 606, communication subsystem 608, and/or other components not shown in FIG. 6. Computing system 600 may also optionally include user input devices such as keyboards, mice, game controllers, cameras, microphones, and/or touch screens, for example.

Logic subsystem 602 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 604 may include one or more physical, non-transitory, devices configured to hold data and/or instructions executable by the logic subsystem to implement the herein described methods and processes. When such methods and processes are implemented, the state of data-holding subsystem 604 may be transformed (e.g., to hold different data).

Data-holding subsystem 604 may include removable media and/or built-in devices. Data-holding subsystem 604 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 604 may include devices with one or more of the following characteristics: volatile, nonvolatile, dynamic, static, read/write, read-only, random access, sequential access, location addressable, file addressable, and content addressable. In some embodiments, logic subsystem 602 and data-holding subsystem 604 may be integrated into one or more common devices, such as an application specific integrated circuit or a system on a chip.

FIG. 6 also shows an aspect of the data-holding subsystem in the form of removable computer-readable storage media 612, which may be used to store and/or transfer data and/or instructions executable to implement the herein described methods and processes. Removable computer-readable storage media 612 may take the form of CDs, DVDs, HD-DVDs, Blu-Ray Discs, EEPROMs, and/or floppy disks, among others.

It is to be appreciated that data-holding subsystem 604 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

When included, display subsystem 606 may be used to present a visual representation of data held by data-holding subsystem 604. As the herein described methods and processes change the data held by the data-holding subsystem, and thus transform the state of the data-holding subsystem, the state of display subsystem 606 may likewise be transformed to visually represent changes in the underlying data. Display subsystem 606 may include one or more display devices utilizing virtually any type of technology. Such display devices may be combined with logic subsystem 602 and/or data-holding subsystem 604 in a shared enclosure, or such display devices may be peripheral display devices.

When included, communication subsystem 608 may be configured to communicatively couple computing system 600 with one or more other computing devices. Communication subsystem 608 may include wired and/or wireless communication devices compatible with one or more different communication protocols. As nonlimiting examples, the communication subsystem may be configured for communication via a wireless telephone network, a wireless local area network, a wired local area network, a wireless wide area network, a wired wide area network, etc. In some embodiments, the communication subsystem may allow computing system 600 to send and/or receive messages to and/or from other devices via a network such as the Internet.

In some embodiments, sensor subsystem 610 may include a depth camera 614. Depth camera 614 may include left and right cameras of a stereoscopic vision system, for example. Time-resolved images from both cameras may be registered to each other and combined to yield depth-resolved video.

In other embodiments, depth camera 614 may be a structured light depth camera configured to project a structured infrared illumination comprising numerous, discrete features (e.g., lines or dots). Depth camera 614 may be configured to image the structured illumination reflected from a scene onto which the structured illumination is projected. Based on the spacings between adjacent features in the various regions of the imaged scene, a depth image of the scene may be constructed.

In other embodiments, depth camera 614 may be a time-of-flight camera configured to project a pulsed infrared illumination onto the scene. The depth camera may include two cameras configured to detect the pulsed illumination reflected from the scene. Both cameras may include an electronic shutter synchronized to the pulsed illumination, but the integration times for the cameras may differ, such that a pixel-resolved time-of-flight of the pulsed illumination, from the source to the scene and then to the cameras, is discernible from the relative amounts of light received in corresponding pixels of the two cameras.

In some embodiments, sensor subsystem 610 may include a visible light camera 616. Virtually any type of digital camera technology may be used without departing from the scope of this disclosure. As a nonlimiting example, visible light camera 616 may include a charge coupled device image sensor.

In some embodiments, sensor subsystem 610 may include motion sensor(s) 618. Example motion sensors include, but are not limited to, accelerometers, gyroscopes, and global positioning systems.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A data holding subsystem holding instructions executable by a logic subsystem to:
output to a display device a user interface including a plurality of selectable items;
receive from a depth camera one or more depth images of a world space scene including a human subject;
identify a world space position of a hand of the human subject;
responsive to the world space position of the hand of the human subject being within a first region, scroll the plurality of selectable items a first direction within the user interface;
responsive to the world space position of the hand of the human subject being within a second region, scroll the plurality of selectable items a second direction, opposite the first direction, within the user interface; and
responsive to the world space position of the hand of the human subject being within a neutral region, between the first region and the second region, holding the plurality of selectable items with one of the plurality of selectable items identified for selection.

2. The data holding subsystem of claim 1, further holding instructions executable by the logic subsystem to:
select the item identified for selection responsive to a user input.

3. The data holding subsystem of claim 2, where the user input is a push gesture in world space.

4. The data holding subsystem of claim 1, where the plurality of selectable items are scrolled with a scroll speed that increases according to a function of a distance of the hand from the neutral region.

5. The data holding subsystem of claim 4, where the function is a step function of the distance of the hand from the neutral region.

6. The data holding subsystem of claim 1, where the world space position of the hand refers to a position of the hand with reference to a first axis in world space, independent of the position of the hand with reference to other axes that are not parallel to the first axis.

7. The data holding subsystem of claim 1, where the user interface is a cursorless user interface without a visual element indicating a position of the hand.

8. A method of controlling a user interface including one or more selectable items, the method comprising:
receiving an attribute of a body part of a human subject, the attribute of the body part changeable between two or more different states;
responsive to the attribute of the body part of the human subject having a first state, scrolling the plurality of selectable items a first direction within the user interface;
responsive to the attribute of the body part of the human subject having a second state, different than the first state, holding the plurality of selectable items with one of the plurality of selectable items identified for selection.

9. The method of claim 8, where the attribute of the body part includes an orientation of a head of the human subject.

10. The method of claim 8, where the attribute of the body part includes a facial expression of the human subject.

11. The method of claim 8, where the attribute of the body part includes a position of a first portion of the body part relative to a position of a second portion of the body part.

12. A method of controlling a user interface including a plurality of selectable items, the method comprising:
receiving a world space placement of a body part of a human subject;
responsive to the world space placement of the body part of the human subject having a first placement, scrolling the plurality of selectable items a first direction within the user interface;
responsive to the world space placement of the body part of the human subject having a second placement, scrolling the plurality of selectable items a second direction, opposite the first direction, within the user interface; and
responsive to the world space placement of the body part of the human subject having a third placement, intermediate the first placement and the second placement, holding the plurality of selectable items with one of the plurality of selectable items identified for selection.

13. The method of claim 12, where the plurality of selectable items is organized in a carousel.

14. The method of claim 12, further comprising:
selecting the item identified for selection responsive to a user input.

15. The method of claim 12, where the plurality of selectable items are scrolled with a scroll speed according to a function of the placement of the body part of the human subject.

16. The method of claim 15, where the function is a step function of the world space placement of the body part of the human subject.

17. The method of claim 12, where the user interface is a cursorless user interface without a visual element indicating a position of the body part of the human subject.

18. The method of claim 12, where the world space placement of the body part refers to a placement of the body part with reference to a first axis in world space, independent of the placement of the body part with reference to other axes that are not parallel to the first axis.

19. The method of claim 18, where the world space placement includes an orientation of the body part.

20. The method of claim 18, where the world space placement includes a position of the body part.
